(19) United States
(12) Patent Application Publication
(10) Pub. No.: US 2010/0124844 A1
(43) Pub. Date: May 20, 2010

(54) STRUCTURAL IMPROVEMENT OF ELECTROMAGNETIC INTERFERENCE SHIELDING DEVICE FOR CARD CONNECTOR

(75) Inventor: Chi-Jung Chan, Sijhih City (TW)

Correspondence Address: ROGER H. CHU, 19499 ERIC DRIVE, SARATOGA, CA, 95070, US

(73) Assignee: Wieson Technologies Co., Ltd., Sijhih City (TW)

(21) Appl. No.: 12/270,958

(22) Filed: Nov. 14, 2008

(51) Int. Cl. H01R 13/648

(52) U.S. Cl. 439/607.01

(57) ABSTRACT

The present invention relates to a structural improvement of an electromagnetic interference shielding device for a card connector, comprising a base of the card connector and an electromagnetic interference shielding device; the base of the card connector comprises a receiving space, a docking device and two male bayonet members; the receiving space is configured for receiving a PC card; the docking device comprises a set of terminals and two ground straps; the electromagnetic interference shielding device is a one-piece cover to shield the docking device, which comprises two female bayonet members, at least two grounding guide spring plates, two grounding fins and two gripping type grounding holders; the two male bayonet members of the base engage with the two female bayonet members; the grounding fins and grounding holders are connected to the two ends of the ground straps.

### BACKGROUND OF THE INVENTION

(a) Field of the Invention

The present invention relates to an improved structure of a PC card slot, and more particularly to an improved structure of an expansion card slot suitable for increasing electromagnetic interference noise-derived contact points so as to have a shorter path to direct the noise to the ground, thus enhancing the electromagnetic interference shielding effect.

(b) Description of the Prior Art

With the development of the times, various electronic products and electrical appliances have come into the lives of modern people, so the electromagnetic radiation appears all around our environment. Not only the electromagnetic radiation of these electromechanical and electronic devices causes injury to human bodies, but it also becomes the interference noise between the devices, thereby influencing the satisfaction thereof and in a work environment and of the expected functions. Accordingly, the overwhelming majority of electromechanical and electronic devices are provided therein with electromagnetic interference shielding devices to shield and block the electromagnetic interference.

Various card connectors mostly also have such kinds of electromagnetic interference shielding devices. Referring to FIG. 1, illustrated is a schematic three-dimensional assembly drawing of a structure of an electromagnetic interference shielding device for a card connector of the prior art. As illustrated in the figure, a card connector 10 is formed by assembling a base 100 of the card connector and an electromagnetic interference shielding device 150. The base 100 of the card connector has a receiving space 110 therein for receiving at least one PC card (not shown). The base 100 of the card connector further has a docking device (not shown) located adjacent to the receiving space 110 for connecting the PC card. A grounding member 120 is formed by extending downwardly from each of the two sides of the docking device.

The electromagnetic interference shielding device 150 is comprised of a grounding iron sheet 160, an upper iron case 170 and a shielding iron case 180. The grounding iron sheet 160 covers and is connected with the docking device to derive the electromagnetic noise therefrom so that the electromagnetic noise is transferred to the shielding iron case 180 through the connection of the upper iron case 170 with the shielding iron case 180.

Referring to FIG. 2, illustrated is a partial three-dimensional assembly drawing of a structure of an electromagnetic interference shielding device for a card connector of the prior art. As illustrated in the figure, the shielding iron case 180 itself further comprises bayonet portions 181, upper grounding fins 182 and grounding spring plates 183. The bayonet portions 181 engage with the base 100 of the card connector so that the shielding iron case 180 can cover the base 100 of the card connector to block the external electromagnetic waves. The grounding fins 182 and the grounding spring plates 183 are respectively connected to the two ends of the grounding member 120 to form two contact points on each of the two sides of the shielding iron case 180. Thus, the electromagnetic noise can be derived from the above contact points.

The structure of an electromagnetic interference shielding device for a card connector of the prior art is a three-piece structure and only four contact points are formed, thus resulting in many drawbacks such as poor conduction efficiency, higher costs and the device of a too complicated structure. An objective of the present invention is to provide an improved structure, and it is expected that the noise conduction efficiency can be increased at the same time as the manufacturing cost can be decreased using a simple structure so as to solve the problems of the structure of an electromagnetic interference shielding device for a card connector of the prior art.

### SUMMARY OF THE INVENTION

The present invention is mainly to provide a structural improvement of an electromagnetic interference shielding device for a card connector, and more particularly to provide a one-piece electromagnetic interference shielding device with grounding holders in place of a three-piece electromagnetic interference shielding device of the prior art.

A structural improvement of an electromagnetic interference shielding device for a card connector according to the present invention comprises a base of the card connector and an electromagnetic interference shielding device. The base of the card connector is an insulated base, comprising a receiving space, a docking device and two male bayonet members. The receiving space is disposed inside the base for receiving at least one PC card. The docking device is located inside the base and at the side adjacent to the receiving space. The docking device at least comprises a set of terminals and two ground straps therein. The set of terminals is electrically connected with the PC card, and the ground straps are respectively located at the appropriate positions on the two sides of the docking device, each of the ground straps being of a strip-like structure and extending from the docking device downwardly to the ground. The one ends of the ground straps are connected to the docking device and the other ends extend downwardly to the ground. The two male bayonet members are respectively located at the two outer sides of the base and close to the docking device.

The electromagnetic interference shielding device is an L-shaped cover of a metallic material to shield the docking device of the base of the card connector, comprising two female bayonet members, at least two grounding guide spring plates, two upper grounding fins and two grounding holders, and all the above elements are formed as one piece with the L-shaped cover. The two female bayonet members are respectively formed on the two side surfaces of the cover and located corresponding to the two male bayonet members of the base of the card connector to engage with the two male bayonet members. The one ends of the grounding guide spring plates are connected with the PC card; the other ends are connected with the ground straps through the upper grounding fins. The upper grounding fins are respectively disposed on the two sides of the cover and located corresponding to the ground straps of the docking device. The grounding holders respectively extend downwardly from the two ends of the cover and form an inverted U-shaped structure with the cover, and the grounding holders are respectively formed with first holding portions and second holding portions that inwardly hold the ground straps of the docking device.

The advantages and spirit of the invention will be more readily apparent from the following detailed description, which proceeds with reference to the accompanying drawings. The drawings are only for reference and illustrative purposes, and thus are not intended to limit the scope of the invention.

### BRIEF DESCRIPTION OF THE DRAWINGS

FIG. 1 is a schematic three-dimensional assembly drawing of a structure of an electromagnetic interference shielding device for a card connector of the prior art.

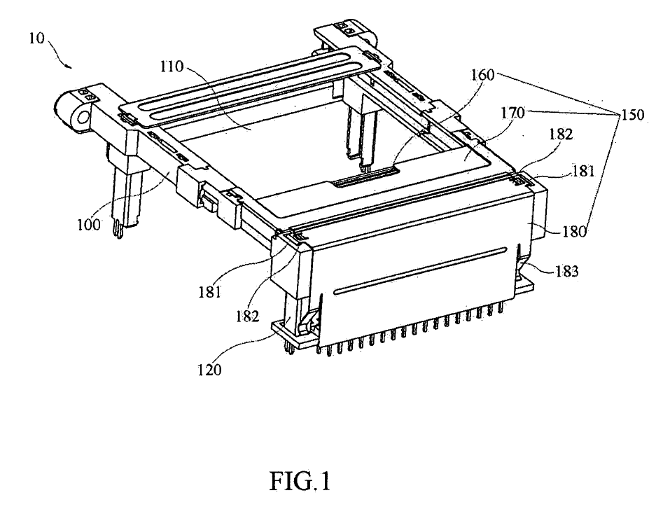

FIG. 2 is a partial three-dimensional assembly drawing of a structure of an electromagnetic interference shielding device for a card connector of the prior art.

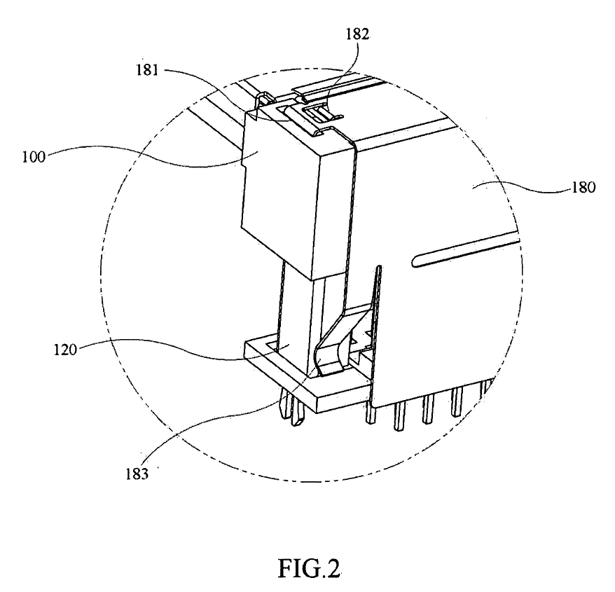

FIG. 3 is a schematic three-dimensional exploded view showing a structural improvement of an electromagnetic interference shielding device for a card connector according to a preferred embodiment of the present invention.

FIG. 4 is a schematic three-dimensional partial view showing a structural improvement of an electromagnetic interference shielding device for a card connector according to a preferred embodiment of the present invention.

FIG. 5 is a partial front view showing a structural improvement of an electromagnetic interference shielding device for a card connector according to a preferred embodiment of the present invention.

FIG. 6 is a schematic three-dimensional assembly drawing showing a structural improvement of an electromagnetic interference shielding device for a card connector according to a preferred embodiment of the present invention.

### DETAILED DESCRIPTION OF THE PREFERRED EMBODIMENTS

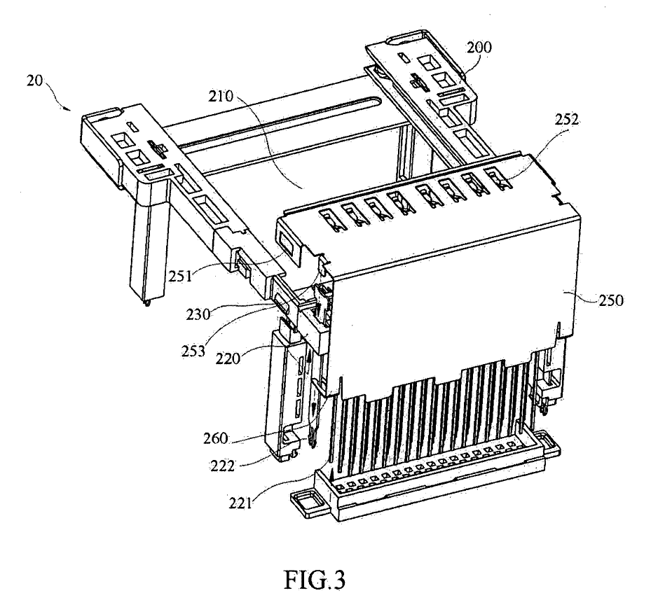

The present invention will become apparent from the following detailed description of the preferred embodiment taken in conjunction with the accompanying drawings. Referring to FIG. 3, illustrated is a schematic three-dimensional exploded view showing a structural improvement of an electromagnetic interference shielding device for a card connector according to a preferred embodiment of the present invention. As illustrated in the figure, a card connector 20 comprises a base 200 of the card connector and an electromagnetic interference shielding device 250. The base 200 of the card connector is an insulated base and is formed therein with a receiving space 210. In addition, the base has a docking device 220 located at one side of the base 200 and adjacent to the receiving space 210, and there are two male bayonet members 230 respectively located at the two outer sides of the base 200 and close to the docking device 220.

The receiving space 210 is located inside the base 200 for receiving at least one PC card (not shown). The docking device 220 is located inside the base 200 and at the side adjacent to the receiving space 210, which further comprises a set of terminals 221 and two ground straps 222 therein. The set of terminals 221 can be electrically connected with the PC card, and the ground straps 222 are respectively located at the appropriate positions on the two sides of the docking device 220, each of the ground straps being of a strip-like structure and extending from the docking device 220 downwardly to the ground. The one ends of the ground straps 222 are connected to the docking device 220 and the other ends extend downwardly to the ground.

The electromagnetic interference shielding device 250 is an L-shaped cover of a metallic material to shield the docking device 220 of the base 200 of the card connector. The electromagnetic interference shielding device 250 comprises two female bayonet members 251, at least two grounding guide spring plates 252, two upper grounding fins 253 and two grounding holders 260, and all the above elements are formed as one piece with the electromagnetic interference shielding device 250. However, in this embodiment, eight guide spring plates 252 are provided, which meets the requirement of at least two guide spring plates 252.

The two female bayonet members 251 are respectively formed on the two side surfaces of the cover of the electromagnetic interference shielding device 250 and located corresponding to the two male bayonet members 230 of the base 200 of the card connector to engage with the two male bayonet members 230. The one ends of the grounding guide spring plates 252 are connected with the PC card; the other ends are connected with the ground straps 222 through the upper grounding fins 253.

The upper grounding fins 253 are respectively disposed on the two sides of the cover of the electromagnetic interference shielding device 250 and located corresponding to the ends of the ground straps 222 that are connected to the docking device 220. The grounding holders 260 respectively extend downwardly from the two ends of the cover of the electromagnetic interference shielding device 250 and form an inverted U-shaped structure with the cover, and the grounding holders 260 are respectively formed with first holding portions 261 and second holding portions 262 that inwardly hold the grounding straps 222 of the docking device 220.

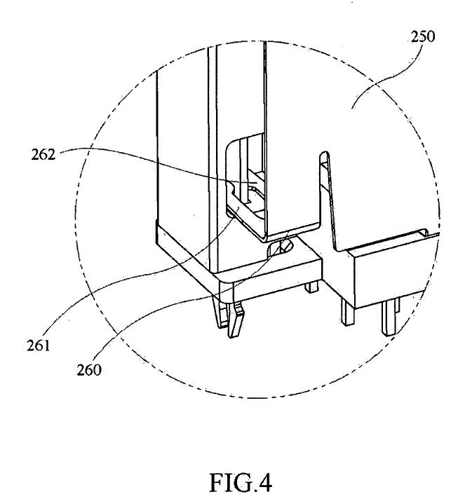

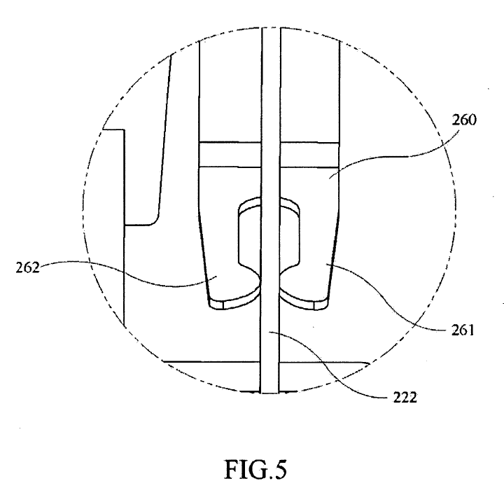

Referring to FIGS. 4 and 5, illustrated are a schematic three-dimensional partial view and a partial front view showing a structural improvement of an electromagnetic interference shielding device for a card connector according to a preferred embodiment of the present invention. It will be apparent from the figures the relationship and positions of the grounding holders 260 and the grounding straps 222 of the docking device 220 of the electromagnetic interference shielding device 250 according to the present invention. As illustrated in the figures, the front end of the grounding holder 260 is folded at 90 degrees and divided into two holding portions that are the first holding portion 261 and the second holding portion 262 respectively. The front ends of the two holding portions protrude and are in point contact with the two side surfaces of the grounding strap 222 respectively, thus forming two contact points to direct the noise to the ground more rapidly.

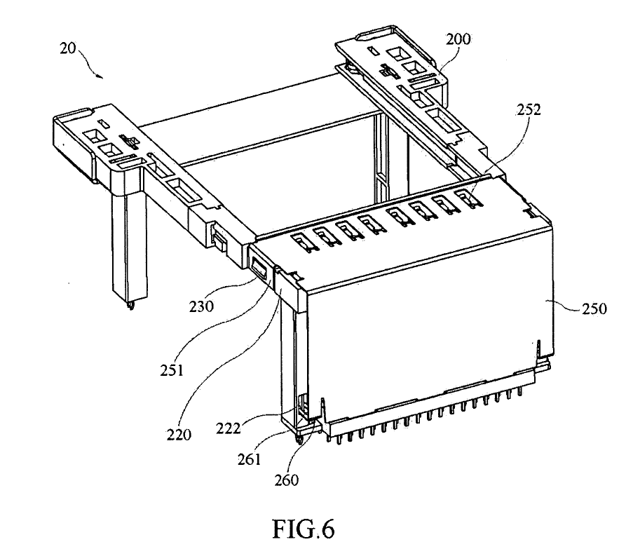

Referring to FIGS. 3 and 6, illustrated are a schematic three-dimensional exploded view and a schematic three-dimensional assembly drawing showing a structural improvement of an electromagnetic interference shielding device for a card connector according to a preferred embodiment of the present invention. As illustrated in the figures, the card connector 20 is formed by combining the base 200 of the card connector with the electromagnetic interference shielding device 250, wherein the electromagnetic interference shielding device 250 at its two sides has the two female bayonet members 251 that engage with the two male bayonet members 230 on the two sides of the base 200 of the card connector so that the electromagnetic interference shielding device 250 can shield the docking device 220. Because the electromagnetic interference shielding device 250 is formed as one piece, the at least two grounding guide spring plates 252, the two upper grounding fins 253 and the two grounding holders 260 of the electromagnetic interference shielding device 250 and the set of terminals 221 and the two ground straps 222 of the docking device 220 can be connected with each other at the same time. The two ends of the ground strap 222 are connected with the upper grounding fin 253 and the grounding holder 260 respectively. More contact points can be used to remove the electromagnetic interference noise through the ground more rapidly and in a shorter path by such design and connection.

In summarization of the foregoing description, it should be known that the present invention possesses industrial utilization, novelty and inventiveness and meets the requirements for a utility model patent. However, it should be understood that the embodiments of the present invention described herein are merely exemplary and that various variations and modifications can be made to the described embodiments without departing from the scope of the invention. All such equivalent variations and modifications are intended to be included within the scope of the invention as defined by the appended claims.

1. A structural improvement of an electromagnetic interference shielding device for a card connector at least comprising:
a base of the card connector comprising:
at least one receiving space, which is formed inside the base for receiving at least one PC card;
at least one docking device, which is located at one side inside the base and adjacent to the receiving space, further comprising:
at least one set of terminals, which is electrically connected with the PC card;
at least two ground straps, which are respectively located at the appropriate positions on the two sides of the docking device, one of the two ends of each ground strap being connected to the docking device, the other end one of the two ends of each ground strap extended from the docking device downwardly to the ground; and
at least two male bayonet members, which are respectively located at the two outer sides of the base and close to the docking device; and
an electromagnetic interference shielding member, which is formed as an L-shaped cover to shield the docking device of the base of the card connector, further comprising:
at least two female bayonet members, which are respectively formed on the two side surfaces of the cover and located corresponding to the two male bayonet members of the base of the card connector to engage with the two male bayonet members of the base of the card connector so that the electromagnetic interference shielding member shields the docking device of the base of the card connector;
at least two grounding guide spring plates, one of the two ends of each grounding guide spring plate being connected with the PC card;
at least two upper grounding fins, which are respectively disposed on the two side surfaces of the cover and located corresponding to the position where the two ground straps of the docking device are located at the docking device, the other one of the two ends of each grounding guide spring plate being connected with the upper grounding fin and one of the two ground straps; and
at least two grounding holders, which respectively extend downwardly from the two ends of the cover, then inwardly bending a certain angle and forming an inverted U-shaped structure with the cover, and continuously being respectively formed with first holding portions and second holding portions that inwardly hold the ground straps of the docking device.

2. The structural improvement of the electromagnetic interference shielding device for the card connector as described in claim 1, wherein the base of the card connector is an insulated base.

3. The structural improvement of the electromagnetic interference shielding device for the card connector as described in claim 1, wherein the ground straps of the docking device is a strip-like ground straps and extends from the docking device downwardly to the ground.

4. (canceled)

5. The structural improvement of the electromagnetic interference shielding device for the card connector as described in claim 1, wherein the electromagnetic interference shielding device is of a metallic material.

6. The structural improvement of the electromagnetic interference shielding device for a card connector as described in claim 1, wherein the female bayonet members, the set of grounding guide spring plates, and the upper grounding fins and the grounding holders of the electromagnetic interference shielding device are formed as one piece with the electromagnetic interference shielding member.

7. The structural improvement of the electromagnetic interference shielding device for the card connector as described in claim I, wherein the certain angle is 90 degrees.
